(19) United States
(12) Patent Application Publication
(10) Pub. No.: US 2007/0018570 A1
(43) Pub. Date: Jan. 25, 2007

(54) ORGANIC ELECTROLUMINESCENCE DEVICE AND METHOD OF FORMING THE SAME

(76) Inventors: Wei-Jen Tai, Chiayi County (TW); Yung-Chia Kuan, Taipei City (TW); Mu-Ching Hung, Hsinchu City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/161,024

(22) Filed: Jul. 20, 2005

(51) Int. Cl. H05B 33/14; H05B 33/24; H05B 33/10

(52) U.S. Cl. 313/504; 313/503; 313/506; 445/24

(57) ABSTRACT

An organic electroluminescence device comprising a plurality of first electrodes, a plurality of first auxiliary electrodes, a plurality of second auxiliary electrodes, a plurality of organic emitting patterns and a plurality of second electrodes is provided. The first electrodes are arranged on a substrate. The first auxiliary electrodes are disposed on at least one edge of the substrate, wherein each first auxiliary electrode is electrically connected with each first electrode. The second auxiliary electrodes are disposed on another edge of the substrate, wherein the first auxiliary electrodes and the second auxiliary electrodes are constituted of a double layer of an aluminium-neodymium (Al—Nd) alloy layer and an aluminium-neodymium nitride layer. The organic emitting patterns are arranged over the first electrodes. The second electrodes are arranged over the organic emitting patterns, wherein each second electrode is electrically connected to each second auxiliary electrode.

### BACKGROUND OF THE INVENTION

1. Field of the Invention

The present invention generally relates to an organic electroluminescence device and a method of forming the same. More particularly, the present invention relates to a passive matrix organic electroluminescence device and a method of forming the same.

2. Description of Related Art

Organic electroluminescent devices are spontaneous emission devices that emit light by electrically exciting fluorescent organic compounds. The organic electroluminescent devices are expected to be applied to next generation display devices that can overcome shortcomings of liquid crystal display devices, with characteristics including a low driving voltage, enabling the production of thin and small display panels having a wide viewing angle, and a high response speed.

Generally, a passive matrix organic electroluminescence device comprises first strip electrodes, second strip electrodes cross the first electrodes and an organic emitting layer sandwiched between the first and second strip electrodes. The first and the second strip electrodes are composed of indium-tin oxide (ITO) so that auxiliary electrodes for electrically connecting with the first/second electrodes and driving circuits are required for improving electrically contact between the first/second electrodes and the driving circuits.

Conventionally, the auxiliary electrodes are made of a multiple layer of Cr/Al/Cr or a single layer of silver (Ag). However, if the auxiliary electrodes are made of the multiple layer of Cr/Al/Cr, more sputtering chambers and etching chambers are required because two metals (Cr and Al) are used. If the auxiliary electrodes are made of the single layer of Ag, the silver is easy oxidized so as to worsen the auxiliary electrode resistance.

### SUMMARY OF THE INVENTION

Accordingly, the present invention is directed to an organic electroluminescence device having low resistance auxiliary electrodes.

The present invention is directed to a method of forming an organic electroluminescence device capable of simplifying manufacturing process and preventing the auxiliary electrodes from oxidizing.

According to an embodiment of the present invention, an organic electroluminescence device comprising a plurality of first electrodes, a plurality of first auxiliary electrodes, a plurality of second auxiliary electrodes, a plurality of organic emitting patterns and a plurality of second electrodes is provided. The first electrodes are arranged on a substrate. The first auxiliary electrodes are disposed on at least one edge of the substrate, wherein each first auxiliary electrode is electrically connected with each first electrode. The second auxiliary electrodes are disposed on another edge of the substrate, wherein the first auxiliary electrodes and the second auxiliary electrodes are constituted of a double layer of an aluminium-neodymium (Al—Nd) alloy layer and an aluminium-neodymium nitride layer. The organic emitting patterns are arranged over the first electrodes. The second electrodes are arranged over the organic emitting patterns, wherein each second electrode is electrically connected to each second auxiliary electrode.

According to an embodiment of the present invention, the aluminium-neodymium alloy layer has a thickness in a range of 100˜400 nm. The aluminium-neodymium nitride layer has a thickness in a range of 5˜100 nm.

According to an embodiment of the present invention, the device further comprises a pixel defining layer disposed over the first electrodes and the pixel defining layer exposes a portion of the first electrodes.

According to an embodiment of the present invention, the device further comprises a separating layer disposed on the pixel defining layer.

According to another embodiment of the present invention, an organic electroluminescence device comprising a plurality of first electrodes, a plurality of first auxiliary electrodes, a plurality of second auxiliary electrodes, a covering layer, a plurality of organic emitting patterns and a plurality of second electrodes is provided. The first electrodes are arranged on a substrate. The first auxiliary electrodes are disposed on at least one edge of the substrate, wherein each first auxiliary electrode is electrically connected with each first electrode. The second auxiliary electrodes are disposed on another edge of the substrate, wherein the first auxiliary electrodes and the second auxiliary electrodes are constituted of a silver layer or a silver alloy layer. The covering layer is disposed on the edges of the substrate to cover a portion of the first and second auxiliary electrodes. The organic emitting patterns are arranged over the first electrodes. The second electrodes are arranged over the organic emitting patterns, wherein each second electrode is electrically connected to each second auxiliary electrode.

According to an embodiment of the present invention, the silver or silver alloy layer has a thickness in a range of 200˜500 nm. The covering layer has a thickness in a range of 500˜4000 nm.

According to another embodiment of the present invention, a method of forming an organic electroluminescence device is described. First, a plurality of first electrodes is formed on a substrate. A plurality of first auxiliary electrodes is formed on at least one edge of the substrate and a plurality of second auxiliary electrodes is formed on another edge of the substrate, wherein each first auxiliary electrode is electrically connected to each first electrode, and the first auxiliary electrodes and the second auxiliary electrodes are constituted of a double layer of an aluminium-neodymium (Al—Nd) alloy layer and an aluminium-neodymium nitride layer. A plurality of organic emitting patterns is formed over the first electrodes. A plurality of second electrodes is formed over the organic emitting patterns, wherein each second electrode is electrically connected to each second auxiliary electrode.

According to an embodiment of the present invention, the step of forming the first auxiliary electrodes and the second auxiliary electrodes comprises: forming a first aluminium-neodymium alloy layer; forming a second aluminium-neodymium alloy layer on the first aluminium-neodymium alloy layer; performing a nitridation step for the second aluminium-neodymium alloy layer to form an aluminium-neodymium nitride layer; and patterning the aluminium-neodymium nitride layer and the first aluminium-neodymium alloy layer so as to form the first and second auxiliary electrodes.

According to an embodiment of the present invention, the method further comprises forming a pixel defining layer over the first electrodes before forming the organic emitting patterns.

According to an embodiment of the present invention, the method further comprises forming a separating layer on the pixel defining layer before forming the second electrodes.

According to another embodiment of the present invention, a method of forming an organic electroluminescence device is described. First, a plurality of first electrodes is formed on a substrate. A plurality of first auxiliary electrodes is formed on at least one edge of the substrate and a plurality of second auxiliary electrodes is formed on another edge of the substrate, wherein each first auxiliary electrode is electrically connected to each first electrode, and the first auxiliary electrodes and the second auxiliary electrodes are constituted of a silver layer or a silver alloy layer. A covering layer is formed on the edges of the substrate to cover a portion of the first and second auxiliary electrodes. A plurality of organic emitting patterns is formed over the first electrodes. A plurality of second electrodes is formed over the organic emitting patterns, wherein each second electrode is electrically connected to each second auxiliary electrode.

According to an embodiment of the present invention, the method further comprises forming a pixel defining layer over the first electrodes before forming the organic emitting patterns. In addition, the covering layer can be formed when forming the pixel defining layer.

According to an embodiment of the present invention, the method further comprises forming a separating layer on the pixel defining layer before forming the second electrodes. In addition, the covering layer is formed when forming the separating layer.

In the present invention, the first and second auxiliary electrodes are constituted of a double layer of an aluminium-neodymium (Al—Nd) alloy layer and an aluminium-neodymium nitride layer. Comparing with the conventional method using Cr/Al/Cr auxiliary electrodes, the method of the present invention only needs one target (Al—Nd alloy target) and one etching recipe to form the first and second auxiliary electrodes so that the process complexity and the process time are reduced.

If the first and second auxiliary electrodes are constituted of silver (Ag) or silver alloy having lower resistance, a covering layer is further formed over the first and second auxiliary electrodes to protect the first and second auxiliary electrodes from oxidizing. In addition, the covering layer can be formed when defining the pixel defining layer or the separating layer so that the number of photo-mask is not increased.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIGS. 1-3 are top views showing a method of forming an organic electroluminescence device according to an embodiment of the present invention.

FIG. 4A is a schematic cross-section view along A-A′ of FIG. 3 showing an organic electroluminescence device having a pixel defining layer and a separating layer according to an embodiment of the present invention.

FIG. 4B is a schematic cross-section view along B-B′ of FIG. 3 showing an organic electroluminescence device having a pixel defining layer and a separating layer according to an embodiment of the present invention.

FIGS. 5-6 are top views showing another method of forming an organic electroluminescence device according to an embodiment of the present invention.

FIG. 7A is a schematic cross-section view along A-A′ of FIG. 6 showing an organic electroluminescence device having a pixel defining layer and a separating layer according to an embodiment of the present invention.

FIG. 7B is a schematic cross-section view along B-B′ of FIG. 6 showing an organic electroluminescence device having a pixel defining layer and a separating layer according to an embodiment of the present invention.

FIG. 8A is a schematic cross-section view along A-A′ of FIG. 6 showing another organic electroluminescence device having a pixel defining layer and a separating layer according to another embodiment of the present invention.

FIG. 8B is a schematic cross-section view along B-B′ of FIG. 6 showing another organic electroluminescence device having a pixel defining layer and a separating layer according to another embodiment of the present invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

### First Embodiment

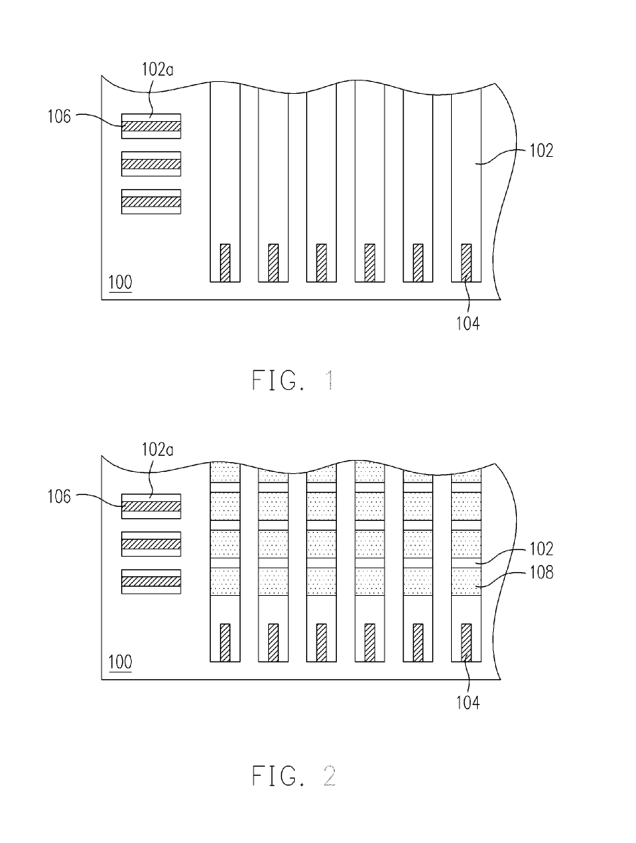

FIGS. 1-3 are top views showing a method of forming an organic electroluminescence device according to an embodiment of the present invention. As shown in FIG. 1, a substrate 100 is provided. The substrate 100 is a glass substrate or a plastic substrate, for example. A plurality of first electrodes 102 are formed on the substrate 100. The first electrodes 102 are constituted of a transparent conductive material, such as ITO or indium-zinc oxide (IZO). The first electrodes 102 are several parallel strips, for example, arranged on the substrate 100.

Next, a plurality of first auxiliary electrodes 104 is formed on at least one edge of the substrate 100, and a plurality of second auxiliary electrodes 106 is formed on another edge of the substrate 100. Each first auxiliary electrode 104 is electrically connected with each first electrode 102. In an embodiment, the first and second auxiliary electrodes 104, 106 are formed at the same time. In addition, the first auxiliary electrodes 104 can be formed on the first electrodes 102 so that each first auxiliary electrode 104 can be electrically connected with each first electrode 102. In another embodiment, when forming the first electrodes 102, a plurality of conductive patterns 102a may also be formed on the edge of the substrate 100 in which the second auxiliary electrodes 106 are sequentially formed on the conductive patterns 102a.

In particular, the first auxiliary electrodes 104 and the second auxiliary electrodes 106 are constituted of a double layer of an aluminium-neodymium (Al—Nd) alloy layer and an aluminium-neodymium nitride layer (not shown). In details, the first auxiliary electrodes 104 and the second auxiliary electrodes 106 are constituted of a lower layer of an aluminium-neodymium alloy and an upper layer of aluminium-neodymium nitride. In an embodiment, the aluminium-neodymium alloy layer has a thickness in a range of 100˜400 nm. The aluminium-neodymium nitride layer has a thickness in a range of 5˜100 nm. The first auxiliary electrodes 104 and the second auxiliary electrodes 106 are formed by the steps of forming a first aluminium-neodymium alloy layer over the substrate by sputtering process; forming a second aluminium-neodymium alloy layer over the first aluminium-neodymium alloy layer by sputtering process; performing a nitridation step for the second aluminium-neodymium alloy layer to form an aluminium-neodymium nitride layer; and patterning the aluminium-neodymium nitride layer and the first aluminium-neodymium alloy layer to form the first and second auxiliary electrodes 104, 106. In an embodiment, the nitridation step is carried out by flowing 100˜150 sccm Ar gas and 1˜10 sccm N2 gas into the sputtering process chamber.

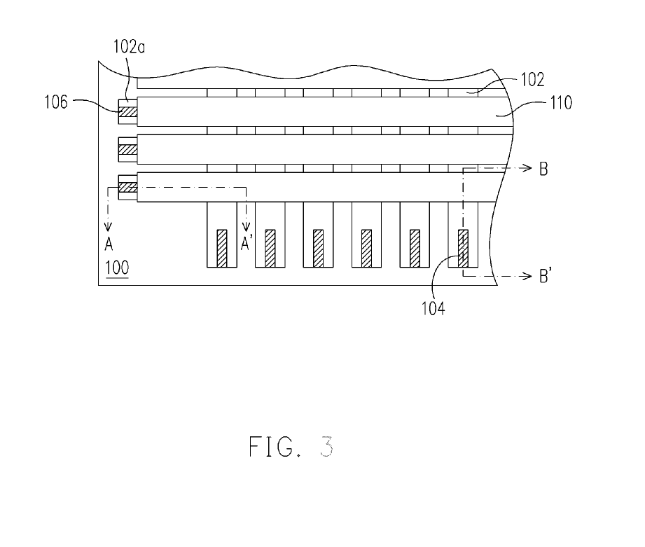

As shown in FIG. 2, after forming the first and second auxiliary electrodes 104, 106, a plurality of organic emitting patterns 108 is formed over the first electrodes 102. The organic emitting patterns 108 arranged over the first electrodes 102 comprises red light organic emitting patterns, green light organic emitting patterns and blue light organic emitting patterns, for example.

Thereafter, as shown in FIG. 3, a plurality of second electrodes 110 is formed over the organic emitting patterns 108, wherein each second electrode 110 is electrically connected to each second auxiliary electrode 106. The second electrodes 110 are composed of several parallel strips arranged over the substrate 100 and are cross the first electrodes 102. In the case, the second electrodes 110 have an extending direction perpendicular to that of the first electrodes 102. The second electrodes 110 are constituted of a transparent conductive material, such as ITO or IZO.

In a preferred embodiment, before forming the organic emitting patterns 108 (shown in FIG. 2), a pixel defining layer and a separating layer are further formed over the substrate 100 that is explained as the following description.

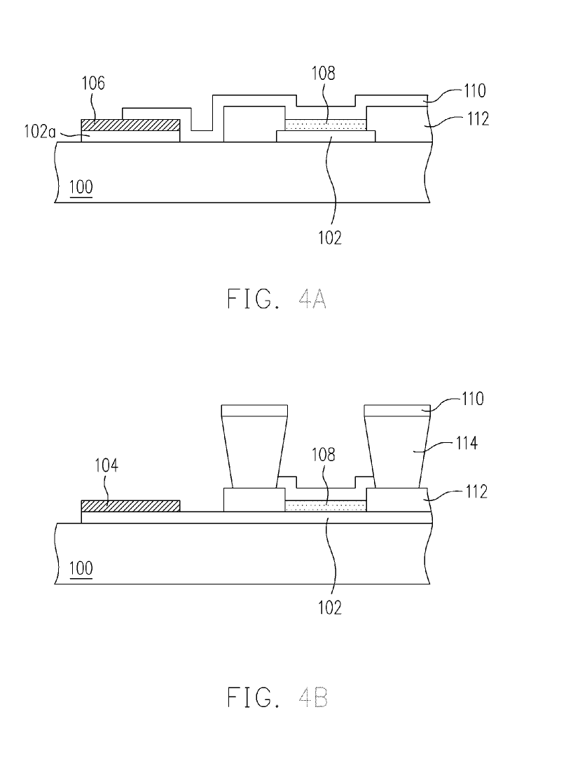

FIG. 4A is a schematic cross-section view along A-A′ of FIG. 3 showing an organic electroluminescence device having a pixel defining layer and a separating layer according to an embodiment of the present invention. FIG. 4B is a schematic cross-section view along B-B′ of FIG. 3 showing an organic electroluminescence device having a pixel defining layer and a separating layer according to an embodiment of the present invention. As shown in FIG. 4A and FIG. 4B, the pixel defining layer 112 is disposed over substrate 100 and the first electrodes 102 and exposes a portion of the first electrodes 102. The pixel defining layer 112 is matrix shape-like so as to define a plurality of pixel units on the substrate 100 so that the organic emitting patterns 108 formed subsequently are in the regions defined by the pixel defining layer 112. In addition, the separating layer 114 is disposed on the pixel defining layer 112, and the separating layer 114 is constituted of several strips perpendicular to the first electrodes 102 (as shown in FIG. 1) so that when depositing a second electrode layer (not shown), the second electrode layer are separated to be several second electrodes 110. The pixel defining layer 112 is a photo-resist material layer, such as polyimide, having a thickness in a range of 500˜1200 nm, for example. The separating layer 114 is a photo-resist material layer, such as a negative photo-resist, having a thickness in a range of 2000˜4000 nm, for example.

In the first embodiment of the present invention, the first and second auxiliary electrodes 104, 106 are constituted of a double layer of an aluminium-neodymium alloy layer and an aluminium-neodymium nitride layer. Comparing with the conventional method using Cr/Al/Cr auxiliary electrodes, the present invention only uses one target (Al—Nd alloy target) and one etching recipe to form the first and second auxiliary electrodes 104, 106 so that the process complexity and the process time are reduced.

### Second Embodiment

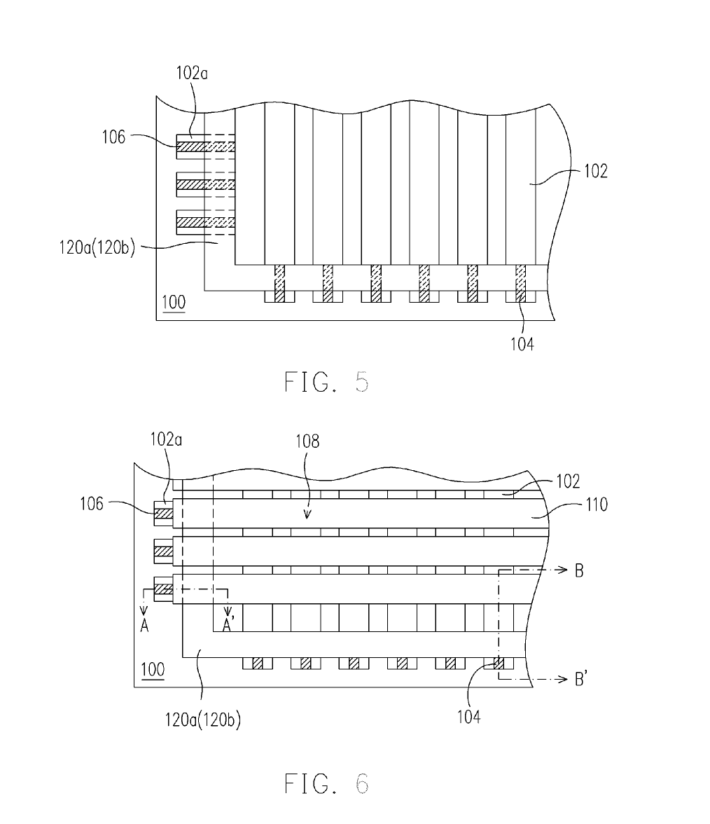

In the second embodiment of the present invention, the method of forming the organic electroluminescence device is similar to the first embodiment except the first and second auxiliary electrodes are constituted of a silver (Ag) layer or a silver alloy layer, and a covering layer is further formed over the first and second auxiliary electrodes. As shown in FIG. 5, after forming the first electrodes 102, a plurality of first auxiliary electrodes 104 and a plurality of auxiliary second electrodes 106 constituted of a single layer of silver or silver alloy are formed on the edges of the substrate 100. In an embodiment, the silver layer or the silver alloy layer has a thickness in a range of 200˜500 nm, for example. Next, a covering layer 120a (or 120b) is formed on the edges of the substrate 100 to cover a portion of the first and second auxiliary electrodes 104, 106. In an embodiment, the covering layer 120a (or 120b) has a thickness in a range of 500˜4000 nm, for example. Thereafter, as shown in FIG. 6, a plurality of organic emitting patterns 108 is formed over the first electrodes, and a plurality of second electrodes 110 is formed over the organic emitting patterns 108, wherein each second electrode 110 is electrically connected to each second auxiliary electrode 106.

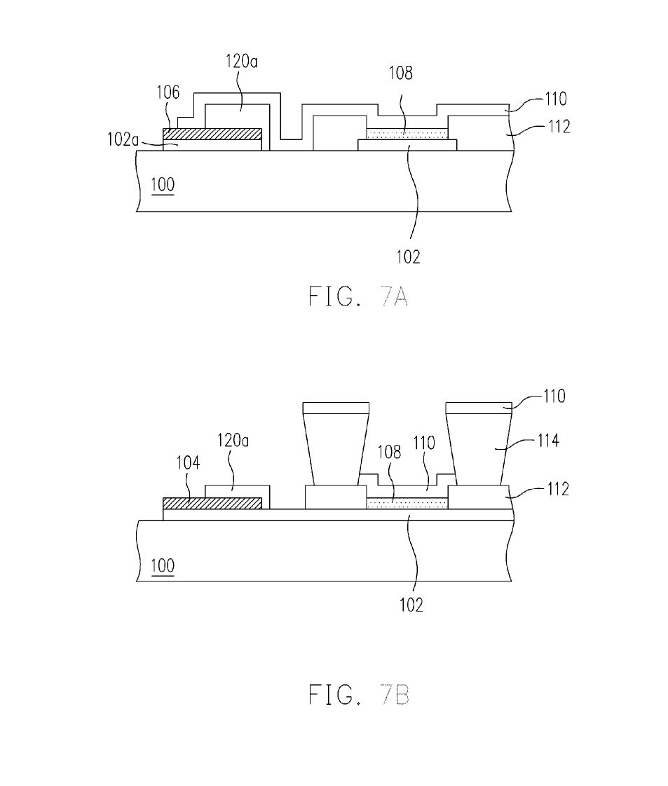

In the second embodiment, a pixel defining layer 112 and a separating layer 114 may also be formed over the substrate 100 (as shown in FIG. 7A and 7B). As shown in FIG. 7A, the pixel defining layer 112 is disposed over substrate 100 and the first electrodes 102 and exposes a portion of the first electrodes 102. The separating layer 114 is disposed on the pixel defining layer 112. In an embodiment, the covering layer 120a can be formed when forming the pixel defining layer 112. In other words, the covering layer 120a and the pixel defining layer 112 are formed at the same time so that covering layer 120a has a material similar to that of the pixel defining layer 112 and has a thickness similar to that of the pixel defining layer 112.

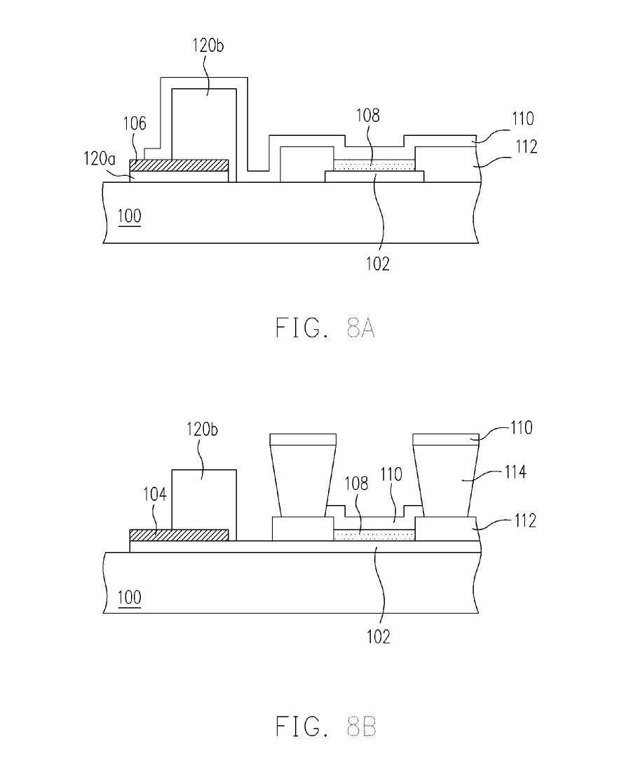

In another embodiment, as shown in FIG. 8A and FIG. 8B, the covering layer 120b can be formed when forming the separating layer 114. In other words, the covering layer 120b and the separating layer 114 are formed at the same time so that covering layer 120b has a material similar to that of the separating layer 114 and has a thickness similar to that of the separating layer 114.

In the second embodiment of the present invention, the first and second auxiliary electrodes are constituted of a silver (Ag) layer or a silver alloy layer having lower resistance, and a covering layer is further formed over the first and second auxiliary electrodes to protect the first and second auxiliary electrodes from oxidizing. In addition, the covering layer can be formed when defining the pixel defining layer or the separating layer so that the number of photo-mask is not increased.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

1. A blank for forming a carton comprising:
a first side panel;
a top panel;
a second side panel;
a bottom panel;
an adhesive flap;
at least one first end flap extending along a first ma area of the blank;
at least one second end flap extending along a second marginal area of the blank;
a tear line extending through at least the top panel, the first side panel and the second side panel, respectively, wherein the tear line extends from the top panel into the first side panel in a first direction substantially perpendicular to the top panel for a first distance to a first; turn in the first side panel, and wherein the tear line extends from the ton panel into the second side panel in the first direction to a first turn in the second side panel;
the tear line extends in a second direction from the first turn in the first side panel through the first side panel into a first side panel end flap, and the tear line extends in the second direction from the first turn in the second side panel through the second side panel into a second side panel end flap;
the first direction being substantially perpendicular to the second direction.

2. The blank of claim 1, wherein the tear line extends into the first side panel a distance greater than halfway between a fold line that separates the top panel and the first side panel and a fold line that separates the first side panel from the adhesive flap.

3. The blank of claim 1, wherein the tear line extends into the second side panel a distance greater than halfway between a fold line that separates the top panel and the second side panel and a fold line that separates the second side panel from the bottom panel.

4. The blank of claim 1, including an access flap formed in the top panel.

5. In combination, a substantially parallelepiped carton formed from the blank of claim 1 and a plurality of articles enclosed within the carton.

6. A blank for forming a carton comprising:
a first side panel;
a top panel;
a second side panel;
a bottom panel;
an adhesive flap;
at least one first end flap extending along a first marginal area of the blank;
at least one second end flap extending along a second marginal area of the blank;
a tear line extending through at least the top panel, the first side panel, and the second side panel, respectively, wherein the tear line extends from the top panel into the first side panel in a first direction substantially perpendicular to the top panel for a distance to a first turn; the tsar line then extending a first run distance in a second direction to a second turn; the tear line then extending in the first direction for a first rise distance to a third turn; the tear line then extending in the second direction through the first side panel into a first side panel end flap and through the second side panel into a second side panel end flap, respectively, the first direction being substantially perpendicular to the second direction.

7. The blank of claim 6, ween the tear line extends into the first side panel a distance greater than halfway between a fold line that separates the top panel and the first side panel and a fold line that separates the first side panel from the adhesive flap.

8. The blank of claim 6, wherein the tear line extends into the second side panel a distance greater than halfway between a fold line that separates the top panel and the second side panel and a fold line that separates the second side panel from the bottom panel.

9. The blank of claim 6, including a finger flap formed in the top panel.

10. In combination, a substantially parallelepiped canon formed from the blank of claim 6 and a plurality of articles enclosed within the carton.

11. A blank for forming a carton comprising:
a first side panel;
a top panel;
a second side panel;
a bottom panel
an adhesive flap;
at least one fat end flap extending along a first marginal area of the blank;
at least one second end flap extending along a second marginal area of the blank;
a tear line extending through at least the top panel the first side panel and the second side panel, respectively, wherein the tear line extends from the top panel into the first side panel in a first direction substantially perpendicular to the top panel for a distance to a first turn; the tear line then extending a first run distance in a second direction to a second turn; the tear line then extending in the first direction for a first rise distance to a third turn; the tear line then extending a second run distance in the second direction to a fourth turn; the tear line then extending in the first direction to a fifth turn; the tear line then extending in the second direction through the fist side panel into a first side panel end flap and through the second side panel into a second side panel end flap, respectively; the first direction being substantially perpendicular to the second direction.

12. The blank of claim 11, wherein the tear line extends into the first side pan a distance greater than halfway between a fold line that separates the top panel and the first side panel and a fold line that separates the fist side panel from the adhesive flap.

13. The blank of claim 11, wherein the tear line extends into the second side panel a distance greater than halfway between a fold line that separates the top panel and the second side panel and a fold line that separates the second side panel from the bottom panel.

14. The blank of claim 11, including an access flap formed in the top panel.

15. In combination, a substantially parallelepiped carton formed from the blank of claim 11 and a plurality of articles enclosed within the carton.

16. A carton for enclosing a plurality of containers, the carton comprising:
a first side panel;
a top panel;
a second side panel;
a bottom panel;
an adhesive flap;
at least one first end flap extending along a first marginal area of the blank;
at least one second end flap extending along a second marginal area of the blank;
a tear line extending through at least the top panel, the first side panel, and the second side panel, respectively, wherein the tear line extends from the top panel into the fist side panel in a first direction substantially perpendicular to the top panel for a first distance to a first turn; the tear line extends from the first turn in the first side panel in a second direction through the first side panel into a first side panel end flap; the first direction being substantially perpendicular to the second direction;
wherein separation of a detachable portion along the tear line creates an opening in the carton though which the containers can be removed.

17. The carton of claim 16, wherein the tear line extends into the first side panel a distance greater than halfway between a fold line that separates the top panel and the first side panel and a fold line that separates the first side panel from the adhesive flap.

18. The carton of claim 16, wherein the tear line extends into the second side panel a distance greater than halfway between a fold line that separates the top panel and the second side panel and a fold line that separates the second side panel from the bottom panel.

19. The carton of claim 16, including a finger flap formed in the top panel.

20. A method of removing articles from a carton, comprising;
providing the carton and plurality of articles according to claim 16;
tearing the carton along at least a part of the tear line;
removing a portion of the carton defined by the tear line to create an opening; and
removing an article from the opening of the carton.

21. A carton for enclosing a plurality of containers, the carton comprising:
a first side panel;
a top panel;
a second side panel;
a bottom panel;
an adhesive flap;
at least one first end flap extending along a first marginal area of the blank;
at least one second end flap extending along a second marginal area of the blank;
a tear line extending through at least the top panel, the first side panel, and the second side panel, respectively, wherein the tear line extends from the top panel into the first side panel in a first direction substantially perpendicular to the top panel for a distance to a first turn; the tear line then extending a first run distance in a second direction to a second turn; the tear line then extending in the first direction for a first rise distance to a third turn; the tear line then extending in the second direction through the first side panel into a first side panel end flap and through the second side panel into a second side panel end flap, respectively; the first direction being substantially perpendicular to the second direction;
wherein separation of a detachable portion along the tear line creates an opening in the carton through which the containers can be removed.

22. The carton of claim 21, wherein the tear line extends into the first side panel a distance greater than halfway between a fold line that separates the top panel and the first side panel and a fold line that separates the first side panel from the adhesive flap.

23. The carton of claim 21, wherein the tear line extends into the second side panel a distance greater than halfway between a fold line that separates the top panel and the second side panel and a fold line that separates the second side panel from the bottom panel.

24. The carton of claim 21, including a finger flap formed in the top panel.

25. A method of removing articles from a carton, comprising:
providing the carton and plurality of articles according to claim 21;
tearing the carton along at least a part of the tear line;
removing a portion of the carton defined by the tear line to create an opening; and
removing an article from the opening of the carton.

26. A carton for enclosing a plurality of containers, the carton comprising:
a first side panel;
a top panel;
a second side panel;
a bottom panel;
an adhesive flap;
at least one first end flap extending along a first marginal area of the blank;
at least one second end flap extending along a second marginal area of the blank;
a tear line extending through at least the top panel, the first side panel, and the second side panel, wherein the tear line extends from the top panel into the first side panel and into the second side panel, respectively, in a first direction substantially perpendicular to the top panel for a distance to a first turn; the tear line then extending a first run distance in a second direction to a second the turn; the tear line then extending in the first direction for a first rise distance to a third turn; the tear line then extending a second ran distance in the second direction to a fourth turn; the tear line then extending in the first direction to a fifth turn; the tear line then extending in the second direction through the first side panel into a first side panel end flap and through the second side panel into a second side panel end flap, respectively; the first direction being substantially perpendicular to the second direction;
wherein separation of a detachable portion along the tear line creates an opening in the carton through which the containers can be removed.

27. The carton of claim 26, wherein the tear line extends into the first side panel a distance greater than halfway between a fold line that separates the top panel and the first side panel and a fold line that separates the first side panel from the adhesive flap.

28. The carton of claim 26, wherein the tear line extends into the second side panel a distance greater than halfway between a fold line that separates the top panel and the second side panel and a fold line that separates the second side panel from the bottom panel.

29. The carton of claim 26, including a finger flap formed in the top panel.

30. A method of removing articles from a carton, comprising:
providing the carton and plurality of articles according to claim 26;
tearing the carton along at least a part of the tear line;
removing a portion of the carton defined by the tear line to create an opening; and
removing an article from the opening of the carton.

31. The carton of claim 26 wherein the tear line extends in the first side panel end flap to a curvilinear turn to extend to a periphery of the first side panel end flap.

32. The an of claim 26 wherein the tear line extends the second side panel end lap to a curvilinear turn to extend to a periphery of the second side panel end flap.

33. The carton of claim 26 wherein the carton includes two closed ends, including an exiting end and a closed end; the tear line extending into the exiting end.

34. A carton for enclosing a plurality of containers, the carton comprising;
a first side panel;
at least one top panel;
a second side panel;
a bottom panel;
at least one first end flap extending along a first marginal area of the blank;
at least one second end flap extending along a second marginal area of the blank;
a tear line extending through the at least one top panel, the first side panel, and the second side panel, wherein the tear line extends from the top panel into the first side panel in a first direction substantially perpendicular to the top panel for a distance to a first turn in the first side panel, and wherein the tear line extends from the top panel into the second side panel in the first direction for a distance to a first turn in the second side panel;
the tear line extends obliquely from the first turn in the first side panel a first oblique distance to a first intersection with a first side panel end flap, and the tear line extends obliquely from the first turn in the second side panel a second oblique distance to a second intersection with a second side panel end flap;
the first and second oblique distances being substantially equal;
wherein separation of a detachable portion along the tar line creates an opening in the carton through which the containers can be removed.

35. The carton of claim 34, wherein the tear line extends into the first side panel a distance greater than halfway between a fold line that separates the top panel and the first side panel and a fold line that separates the first side panel from the adhesive flap.

36. The carton of claim 34, wherein the tear line extends into the second side panel a distance greater than halfway between a fold line that separates the top panel and the second side panel and a fold line that separates the second side panel from the bottom panel.

37. The carton of claim 34, including a finger flap formed in the top panel.

38. A method of removing articles from a carton, comprising:
providing the carton and plurality of articles according to claim 34;
tearing the carton along at least a part of the tear line;
removing a portion of the carton defined by the tear line to create an opening; and
removing an article from the opening of the carton.

39. The carton of claim 34 wherein the tear line extends in the first side panel end flap to a curvilinear turn to extend to a periphery of the fist side panel end flap.

40. The carton of claim 34 wherein the tear line extends in the second side panel end flap to a curvilinear turn to extend to a periphery of the second side panel end flap.

41. The carton of claim 34 wherein the carton includes two closed ends, including an exiting end and a closed end; the tear line extending into the exiting end.

42. The carton of claim 41, further including a positioning assembly at the closed end that elevates the closed end slightly above the exiting end when engaged.

43. The carton of claim 42, wherein the positioning assembly is an unitary structure that remains attached to the carton and comprises a portion of the bottom panel and a portion of the closed end.

44. The carton of claim 43, wherein the positioning assembly is defined by a first fold line extending from a first point on the bottom panel to a second point on the bottom panel and a first positioning tear line extend from the first point across the bottom panel, the closed end, and the bottom panel to the point.

45. The carton of claim 44, further including a first positioning finger flap located along the first positioning tear line; the first positioning finger flap enabling pulling of the positioning assembly along the first positioning tear line.

46. A carton for enclosing a plurality of containers, the carton comprising;
a first side panel;
a top panel;
a second side panel;
at least one bottom panel;
at least one first end flap extending along a first marginal area of the blank;
at least one second end flap extending along a second marginal area of the blank;
a first fold line extending between the first side panel and the top panel, a second fold line extending between the top panel and the second side panel, and a third fold line extending between at least the first side panel and the first end flap;
a tear line extending the top panel, across and along the first fold line,
across and along the second fold line, and across and along the third fold line to define a detachable portion;
wherein separation of the detachable portion along the to line creates an opening in the carton through which the containers can be removed.

47. A carton for enclosing a plurality of containers, the carton comprising:
at least two ends, with one end being an exiting end;
a first side panel;
a top panel;
a second side panel;
at least one bottom panel;
at least one first end flap extending along a first marginal area of the blank;
at least one second end flap extending along a second marginal area of the blank;
a first fold line extending between the first side panel and the top panel, a second fold line extending between the top panel and the second side panel, and a third fold line extending between at least the first side panel and the first end flap;
a tear line extending through the top panel, across and along the first fold line, across and along the second fold line, and across the third fold line into the exiting end to define a detachable portion:
wherein separation of the detachable portion along the tear line creates an opening in the carton through which the containers can be removed.

48. A blank for forming a carton comprising:
at least one side panel;
a top panel;
at least one bottom panel;
at least one first end flap extending along a first marginal area of the blank; and
a tear line extending through at least the top panel and through a portion of at least one of the at least one first end flaps to define a detachable portion of the blank.

49. The carton of claim 46, wherein portions of the tear line respectively extend parallel to the first fold line, the second fold line, and the third fold line.

50. The carton of claim 47 wherein portion of the tear line respectively extend parallel to the first fold line, the second fold line, and the third fold line.
